(19) United States
(12) Patent Application Publication
(10) Pub. No.: US 2025/0078656 A1
(43) Pub. Date: Mar. 6, 2025

(54) DEPLOYABLE DEVICE SYSTEM FOR SCENE

(71) Applicant: Oshkosh Corporation, Oshkosh, WI (US)

(72) Inventors: Korry Kobel, Oshkosh, WI (US); Brandon Tucker, Oshkosh, WI (US); Bob Nelson, Oshkosh, WI (US)

(73) Assignee: Oshkosh Corporation, Oshkosh, WI (US)

(21) Appl. No.: 18/818,302

(22) Filed: Aug. 28, 2024

Related U.S. Application Data
(60) Provisional application No. 63/579,733, filed on Aug. 30, 2023.
(60) Provisional application No. 63/536,177, filed on Sep. 1, 2023.

(51) Int. Cl. G08G 1/0955; B60Q 7/00; G05D 1/69; G05D 105/55; G05D 107/13; G05D 107/90

(52) U.S. Cl. CPC G08G 1/0955; B60Q 7/00; G05D 1/69; G05D 2105/55; G05D 2107/13; G05D 2107/90

(57) ABSTRACT

A deployable device system including a deployable device, a vehicle, and a control system. The deployable device includes a propulsive element coupled to the deployable device, a motor coupled to the deployable device and the propulsive element and configured to drive the propulsive element to propel the deployable device, and an indicator configured to provide one or more indications to an operator of an approaching vehicle. The vehicle is configured to transport the deployable device to a scene and deploy the deployable device. The control system is configured to control the motor to position the deployable device at a position along a perimeter established proximate the scene, and control the indicator to provide an indication.

### CROSS-REFERENCE TO RELATED PATENT APPLICATIONS

This application claims the benefit of and priority to U.S. Provisional Application No. 63/579,733, filed on Aug. 30, 2023 and U.S. Provisional Patent Application No. 63/536,177, filed on Sep. 1, 2023, the entire disclosures of which are hereby incorporated by reference herein.

### BACKGROUND

For an operator of a vehicle that often parks along the side of a road and/or is dispatched to a scene (e.g., emergency scene, construction site, road work etc.), it can be dangerous to place warning devices around the vehicle and/or the scene. Traditionally, to warn drivers of oncoming and approaching vehicles of the vehicle and/or the scene, the operator must walk along busy highways and streets to make the presence of the vehicle and the scene visible. This can place the safety of the operator at risk, who is at an increased risk of being struck and injured by the oncoming and approaching vehicles.

### SUMMARY

One embodiment relates to a deployable device system. The deployable device system includes a deployable device, a vehicle, and a control system. The deployable device includes a propulsive element coupled to the deployable device, a motor coupled to the deployable device and the propulsive element and configured to drive the propulsive element to propel the deployable device, and an indicator configured to provide one or more indications to an operator of an approaching vehicle. The vehicle is configured to transport the deployable device to a scene and deploy the deployable device. The control system is configured to control the motor to position the deployable device at a position along a perimeter established proximate the scene, and control the indicator to provide an indication.

Another embodiment relates to a deployable device. The deployable device includes a chassis, a propulsive element coupled to the chassis, a motor coupled to the chassis and the propulsive element and configured to drive the propulsive element to propel the deployable device, an indicator configured to provide one or more indications to an operator of an approaching vehicle, and a control system configured to control the motor to position the deployable device at a position along a perimeter established proximate a scene, and control the indicator to provide an indication of the scene.

Still another embodiment relates to a deployable device system for controlling operation of a plurality of deployable devices. The deployable device system includes one or more processing circuits comprising one or more memory devices coupled to one or more processors, the one or more memory devices configured to store instructions thereon that, when executed by the one or more processors, cause the one or more processors to control a motor of each deployable device of the plurality of deployable devices to space the plurality of deployable devices along a perimeter established proximate a scene, and control an indicator of each deployable device of the plurality of deployable devices to provide an indication. The indication includes at least one of an audible sound or a visual alert. The indication is indicative of at least one of an instruction for the approaching vehicle to slow down, merge lanes, or stop.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is block diagram of a deployable device system, according to an exemplary embodiment.

FIG. 2 is a side plan view of a vehicle of FIG. 1, according to an exemplary embodiment.

FIG. 3 is a block diagram of a storage area of the vehicle of FIG. 1, according to an exemplary embodiment.

FIG. 4 is a block diagram of a deployable device of the deployable device system of FIG. 1, according to an exemplary embodiment.

FIG. 5 is a diagram showing the vehicle of FIG. 1 and a plurality of deployable devices of FIG. 4 at a scene, according to an exemplary embodiment.

FIG. 6 is a diagram showing the vehicle of FIG. 1 and a plurality of deployable devices of FIG. 4 at a scene, according to an exemplary embodiment.

FIG. 7 is a front perspective view of the deployable device of FIG. 4 configured as a barrier at a scene, according to an exemplary embodiment.

FIG. 8 is a block diagram of the deployable device of FIG. 4 configured as an aerial vehicle, according to an exemplary embodiment.

FIG. 9 is a block diagram of a method for deploying deployable devices, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures, the various exemplary embodiments disclosed herein relate to systems, apparatuses, and methods for deploying, communicating with, and coordinating one or more deployable devices around a vehicle at a scene (e.g., emergency scene, construction site, etc.). The deployable devices are deployed around the vehicle automatically, and are generally configured to warn drivers of oncoming, approaching, and neighboring vehicles that they are approaching the scene. Similarly, the deployable devices enhance the visibility of the vehicle at the scene and the area surrounding the scene and the vehicle. The deployable devices are communicably coupled to the vehicle via wireless communication, whereby the deployable devices and the vehicle may send and receive various signals to coordinate control of the deployable devices and the vehicle. Likewise, each of the deployable devices may communicate with other deployable devices via wireless communication.

In some embodiments, the deployable devices are coordinated to establish a perimeter or boundary around the vehicle and/or the scene. For example, one deployable device may be communicably coupled to the other deployable devices in series (e.g., one deployable device is communicably coupled to neighboring or adjacent deployable devices). As another example, a plurality of deployable devices are communicably coupled in a meshed network arrangement such that any one deployable device may communicate with any other deployable device and the vehicle. The perimeter or boundary may be a predetermined area around the vehicle and/or scene established by lining up or otherwise arranging the deployable devices around the vehicle and/or scene. In an example where the vehicle is driving along a road, the deployable devices may be coordinated to follow the vehicle as it drives along the road while generally maintaining the perimeter or boundary around the vehicle. Operations of the deployable devices relative to the vehicle, scene, and/or other deployable devices may be managed by a controller of the deployable devices and/or a controller of the vehicle.

### System Overview

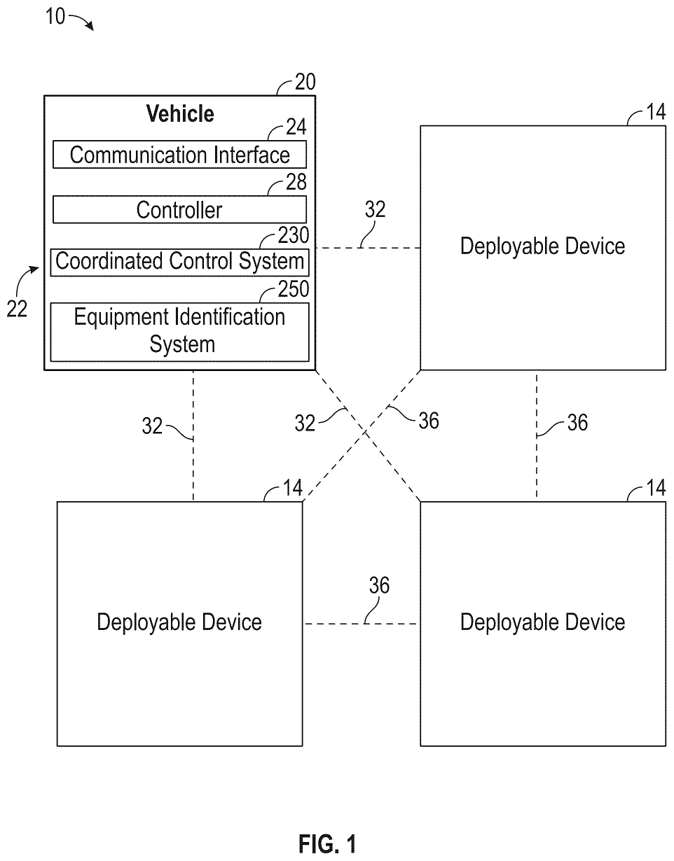

According to the exemplary embodiment shown in FIG. 1, a hazard warning system, traffic system, deployable device system, etc., is shown as system 10. The system 10 is configured to warn oncoming vehicles (e.g., vehicles driving in a direction towards the vehicle from in front of the vehicle), approaching (e.g., vehicles driving in a direction towards the vehicle from behind the vehicle), and neighboring vehicles (e.g., vehicles driving along-side/adjacent to the vehicle), and the drivers thereof, and/or pedestrians, that they are approaching a disabled/parked vehicle, an emergency vehicle, an emergency scene, a construction site, roadwork, or any other hazards that the vehicle should avoid. Driving or walking in, on, or around these areas, objects, and hazards may damage one or more components of the system 10, damage the oncoming, approaching, or neighboring vehicles, be dangerous for one or more operators or pedestrians, be illegal (e.g., entering an emergency scene), etc.

As shown in FIGS. 1-8, the system 10 includes one or more autonomous, partially autonomous, or remote-controlled robots, ground vehicles, or aerial drones, shown as deployable devices 14, a car, truck, emergency vehicle, refuse vehicle, or any other reconfigurable vehicle, shown as vehicle 20 around which the deployable devices 14 deploy, a control system 22 operatively coupled to the deployable devices 14 and the vehicle 20. The deployable devices 14 may deploy (e.g., automatically deploy) around the vehicle 20 or a scene (e.g., scene 210) to establish a perimeter or boundary therearound. By way of example, the deployable devices 14 may be deployed responsive to a command initiated by an operator. Generally, the deployable devices 14 are configured to provide an indication to pedestrians and/or oncoming, approaching, and neighboring vehicles of the vehicle 20 or scene around which the deployable devices 14 have established a perimeter. The deployable devices 14 may enhance the visibility of the vehicle 20 or scene to provide other vehicles with an indication to merge lanes, slow the vehicle, stop the vehicle, or otherwise avoid the vehicle 20 or scene.

As shown in FIG. 1, the vehicle 20 is configured to facilitate wireless communication between the deployable devices 14 and the vehicle 20 via a wireless communication network to coordinate establishing the perimeter around the vehicle 20. For example, when the vehicle 20 is dispatched to a scene (e.g., emergency site, construction site, roadwork, etc.), the vehicle 20 communicates with one or more of the deployable devices 14 by sending and receiving various signals relating to an indication to deploy the deployable devices 14 from the vehicle 20, arrange the deployable devices 14, and form the perimeter around the vehicle 20.

As shown in FIG. 1, the control system 22 is operatively coupled to one or more of the deployable devices 14 and the vehicle 20 to control operation of one or more components thereof. The control system 22 includes a communication interface 24 and a controller 28. In some embodiments, the control system 22 is located on (e.g., integrated into, etc.) the vehicle 20. In other embodiments, a remotely located command center/server may provide commands to the control system 22 via the communication interface 24 to control operation of the deployable devices 14 and the vehicle 20. Each of the connected devices (e.g., the deployable devices 14, the vehicle 20, etc.) may be each configured to provide information, data, or commands to all of the other connected devices, regardless of the connected device network configuration (e.g., fully connected mesh, partially connected mesh, etc.). The communication interface 24 is configured to facilitate wireless communication between the vehicle 20 and the deployable devices 14. More specifically, the communication interface 24 facilitates communication between the controller 28 of the vehicle 20 and the deployable devices 14, other assets, and/or other vehicles. The communication interface 24 may include programming and/or hardware-based components that connect the controller 28 of the vehicle 20 to one or more deployable devices 14, other assets, and/or other vehicles over a network. For example, the communication interface 24 may include any combination of a wireless network transceiver (e.g., Bluetooth™ transceiver, cellular modem, a Wi-Fix transceiver) and/or wired network transceiver (e.g., an Ethernet transceiver). In some arrangements, the communication interface 24 includes hardware and machine-readable media structured to support communication over multiple channels of data communication (e.g., wireless, Bluetooth®, near-field communication, etc.). In yet other arrangements, the communication interface 24 may include one or more cryptography modules to establish a secure communication session (e.g., using the IPSec protocol or similar) in which data communicated over the session is encrypted and securely transmitted.

According to an exemplary embodiment, the controller 28 is communicably coupled to the communication interface 24. In some embodiments, the controller 28 includes the communication interface 24. The controller 28 may also include a processing circuit. The processing circuit may include one or more processors and a memory. The processor may be a general or specific purpose processor, an application specific integrated circuit (ASIC), one or more field programmable gate arrays (FPGAs), a group of processing components, or other suitable processing components. According to an exemplary embodiment, the one or more processors may be coupled to the memory and may be configured to execute computer code or instructions stored in the memory or received from other computer-readable media (e.g., USB drive, network storage, remote server, etc.). The memory may include one or more memory devices (e.g., memory units, storage devices, etc.) for storing data and/or computer code for completing and/or facilitating the various processes described herein. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, or any other type of information structure for supporting the various activities described herein in connection with the systems, apparatuses, and methods for coordinating and dynamically controlling the deployable devices 14. The memory may be communicably coupled to the processor and may include computer code that, when executed by the one or more processors, performs one or more of the processes described herein.

The controller 28 may be configured to transmit commands, data, or information to the deployable devices 14, other assets, and/or other vehicles, where the commands, data, or information may be transmitted via the communication interface 24, as described above. Likewise, the controller 28 may be configured to receive commands, data, or information from the deployable devices 14, where the commands, data, or information may be received via the communication interface 24. In some embodiments, the commands, data, or information transmitted from or received by the controller 28 is related to the coordination of the deployable devices 14 around the vehicle 20 or the scene and the coordination of warning devices of the deployable devices 14 with other deployable devices 14 and with the vehicle 20, as is discussed in detail below. In some embodiments, the commands, data, or information transmitted from or received by the controller 28 is related to the formation of a perimeter around the vehicle 20 established by a plurality of coordinated deployable devices 14. A perimeter may be established to coordinate the warning devices of the deployable devices 14 in a particular way to provide an indication (e.g., a warning, an alert, etc.) to other vehicles (e.g., oncoming drivers, approaching drivers, neighboring drivers, etc.) of the vehicle 20 and scene, provide an indication to perform various hazard avoidance procedures (e.g., merge, slow down, stop, etc.), and/or provide a barrier between the other vehicles and an operator of the vehicle 20 and any other individuals near the vehicle 20 or the scene.

As shown in FIG. 1, the vehicle 20 is configured to transmit a signal 32 that is configured to be received by the deployable devices 14. The signal 32 may be associated with various commands, data, or information relating to the coordination of the deployable devices 14 and the vehicle 20. In some embodiments, the signal 32 from the vehicle 20 is transmitted to each deployable device 14 separately and has a unique signal signature such that the signal 32 transmitted to one deployable device 14 is identified from a plurality of other signals 32 transmitted to other deployable devices 14. In such embodiments, the signal 32 transmitted from the vehicle 20 commands one deployable device 14 to perform a specific function that may be the same or different from a function performed by a different deployable device 14 in response to a command received from a different signal 32 of the vehicle 20.

The deployable device 14 may be configured to transmit commands, data, or information to other deployable devices 14 in a mesh network arrangement. In some embodiments, each of the deployable devices 14 is configured to communicably couple to every other deployable device 14 via a fully connected mesh network. In other embodiments, a plurality of deployable devices 14 are configured to form a plurality of connected networks whereby each of the deployable devices 14 is communicably coupled to a subset of the plurality of deployable devices 14, such as only to a subset of deployable devices 14 within a predetermined range or distance. The mesh network formed by the plurality of deployable devices 14 may be a self-healing network such that the network operates even if/when a deployable device 14 ceases to function or is otherwise disconnected from the network. Relatedly, the mesh network may “self-heal” or reconfigure itself using shortest path bridging and/or transparent interconnection of lots of links. In various embodiments, the mesh network of deployable devices 14 communicates messages using one of various routing techniques where data, information, or commands are propagated through the mesh network, such as a unicast method (message propagated to a single, specific deployable device 14), a multicast method (message propagated to a subset of the deployable devices 14), a broadcast method (message propagated to all of the deployable devices 14), or an anycast method (message propagated to the nearest deployable device 14). Communicating in the mesh network arrangement, the deployable devices 14 are configured to send and receive a signal 36. The signal 36 may be associated with various commands, data, or information relating to the coordination of the deployable devices 14 around the vehicle 20 and/or scene. In such embodiments, the deployable device 14 transmits the signal 36 to any one or more other deployable devices 14. In various embodiments, the mesh network includes the vehicle 20, other vehicles or assets, and/or a central dispatch center.

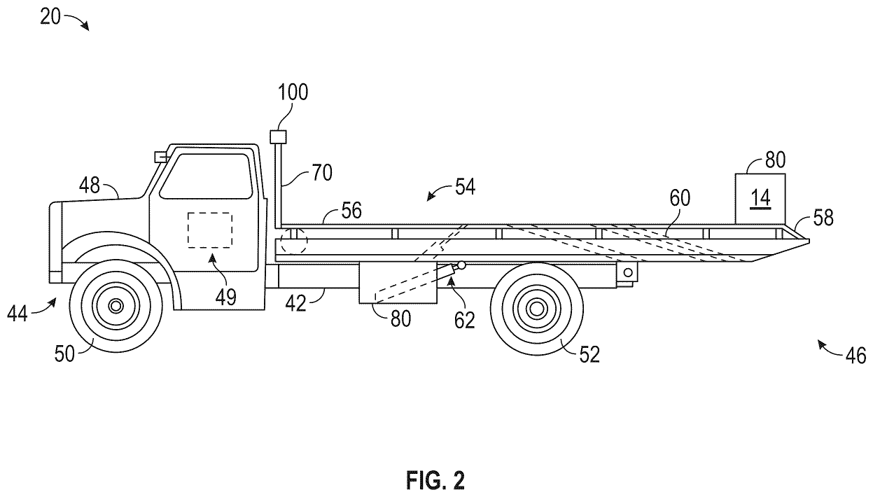

As shown in FIG. 2, the vehicle 20 is a carrier truck or flatbed tow truck configured to facilitate transporting another vehicle or object. In some embodiments, the vehicle 20 is another type of tow truck such as an integrated tow truck, a hook and chain tow truck, a wheel-lift tow truck, etc. In still other embodiments, the vehicle 20 is another type of vehicle such as a response vehicle, a police vehicle, an ambulance, a Department of Transportation vehicle, a roadside assistance vehicle, a fire truck, a refuse truck, a plow truck, a construction vehicle, a street sweeper, a meter-maid vehicle, and/or still another type of vehicle (e.g., a vehicle that stops frequently, a vehicle that is often parked at the side of a road, a vehicle that is often used in severe weather conditions, etc.).

As shown in FIG. 2, the vehicle 20 includes a chassis, shown as frame 42. The frame 42 is a support structure for various components of vehicle 20. According to an exemplary embodiment, the frame 42 includes a pair of frame rails that are arranged in parallel. The pair of frame rails extend along a longitudinal direction (e.g., a fore and aft direction) between a front end 44 of the vehicle 20 and a rear end 46 of the vehicle 20. A longitudinal axis of the vehicle 20 extends parallel to the longitudinal direction between the pair of frame rails.

As shown in FIG. 2, the vehicle 20 includes a cabin or passenger compartment, shown as cab 48, that is supported by the front end 44 of the frame 42. According to an exemplary embodiment, the cab 48 includes a seat and an enclosure to facilitate operation of the vehicle 20 by an operator. The cab 48 may also include components utilized by the operator during operation of vehicle 20 (e.g., hydraulic controls, switches, steering wheel, accelerator, brake, interfaces, etc.). The cab 48, in addition to the driver (e.g., operator), may accommodate one or more passengers (e.g., one passenger, two passengers, three passengers, four passengers, five passengers, six passengers, etc.).

Further, the cab 48 may include lights, gauges, speakers, graphical user interfaces, etc., shown as user interface component 49 that provide information to the operators. The user interface component 49 within the cab 48 may facilitate operator control over the drive components of the vehicle 20 and/or over any implements of the vehicle 20. The user interface component 49 is operatively coupled to the controller 28 to facilitate communication between the operator of the vehicle 20 (e.g., driver) and the deployable devices 14 and the vehicle 20. The user interface component 49 may include one or more input devices (e.g., touchscreens, buttons, switches, microphones, keyboards, mice, etc.) that facilitate the operator providing inputs (e.g., commands) to the controller 28 and/or one or more deployable devices 14. The operator may manually or automatically control operation, coordination, and positioning of the deployable devices 14 via the user interface component 49. The user interface component 49 may include one or more output devices (e.g., displays, speakers, haptic feedback devices, etc.) that facilitate providing information to the operator relating to the deployment, coordination, and current location of the deployable devices 14 around the vehicle 20. The operator may initiate a request through the user interface component 49 to automatically deploy the deployable devices 14 to establish the perimeter around the vehicle 20. Similarly, the operator may initiate a request through the user interface component 49 to automatically return the deployable devices 14 to the vehicle 20. In some embodiments, the user interface component 49 is located elsewhere about the vehicle 20.

According to an exemplary embodiment, a plurality of tractive elements (e.g., wheels) are rotatably coupled to axles that are coupled to the frame 42. As shown in FIG. 2, the vehicle 20 includes a first axle, shown as front axle 50, positioned proximate the front end 44 of the vehicle 20 and a second axle, shown as rear axle 52, positioned proximate the rear end 46 of the vehicle 20. In some embodiments, the vehicle 20 includes two or more rear axles 52. In various embodiments, the vehicle 20 has any number of wheel configurations including three, four, six, eight, or eighteen wheels, among other alternatives.

As shown in FIG. 2, the vehicle 20 includes a rear assembly (e.g., a bed assembly, a rear compartment, a box container, a refuse compartment, a rear fire truck assembly, etc.), shown as rear assembly 54, positioned behind the cab 48. In some embodiments, the vehicle 20 does not include the rear assembly 54 (e.g., in embodiments where the vehicle 20 is a sedan, SUV, etc.). As shown in FIG. 2, the rear assembly 54 has a first end, shown as fore end 56, and an opposing second end, shown as aft end 58. As shown in FIG. 2, the rear assembly 54 includes (i) a support platform, shown as platform 60, that is configured to support a vehicle or other object and (ii) a front support, shown as headboard 70, coupled to and extending vertically upward from the fore end 56 of the platform 60. According to the exemplary embodiment shown in FIG. 2, the platform 60 is movable relative to the frame 42 between a loading position and a transport position via an actuator assembly, shown as platform actuator assembly 62. In the loading position, the platform 60 forms an inclined ramp with the ground (e.g., to facilitate pulling a vehicle onto the platform 60, etc.). The platform actuator assembly 62 may include one or more actuators. The one or more actuators may be hydraulically-operated actuators, pneumatically-operated actuators, and/or electrically-operated actuators. In other embodiments, the platform 60 is fixed relative to the frame 42. In still other embodiments, the rear assembly 54 does not include the platform 60 and/or the headboard 70. By way of example, the rear assembly 54 may be otherwise designed or configured to suit another intended use of the vehicle 20 (e.g., a refuse compartment for a refuse truck, a truck bed for a truck, a box container for a box truck, a box container for an ambulance, a rear fire truck assembly for a fire truck, etc.).

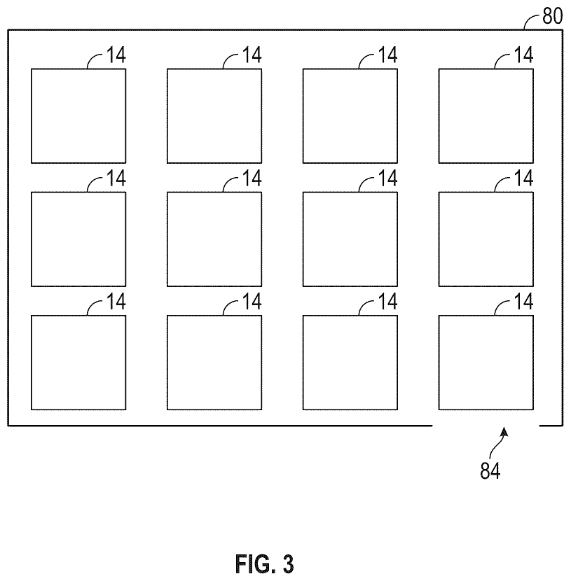

As shown in FIGS. 2 and 3, the vehicle 20 includes a storage area 80 to store, transport, or house one or more deployable devices 14 when not in use. The storage area 80 may be a space dedicated to the storage of the deployable devices 14, or may be a space shared between components of the vehicle 20 (e.g., batteries). The positioning of the storage area 80 varies based on the configuration of the vehicle 20 and the particular use case of the vehicle 20. For example, in an embodiment where the vehicle 20 is a tow truck, the storage area 80 may be positioned behind the cab 48 and on top of the platform 60. In other embodiments, the storage area 80 may be positioned behind the cab 48, extend forward of the cab 48, or behind the cab 48 and forward of the rear assembly 54. In yet other embodiments, the storage area 80 is positioned on the left side, right side, or rear side of the frame 42. In such embodiments, the storage area 80 may include arms configured to engage with the deployable devices 14 to selectively couple the deployable devices 14 to the vehicle 20. The arms may be manually or automatically actuated to release (e.g., deploy) the deployable devices 14 or hold (e.g., store, carry, lift, etc.) the deployable devices 14 during transport. In yet other embodiments, the storage area 80 is otherwise positioned throughout the vehicle 20.

The storage area 80 may include one or more chargers to recharge one or more energy storage devices (e.g., batteries) of the deployable devices 14. As shown in FIG. 3, the storage area 80 further includes an opening (e.g., ingress/egress, door, etc.), shown as section 84, through which the deployable devices 14 enter and exit the storage area 80. The section 84 may include a ramp or track that the deployable devices 14 travel on to enter or exit the storage area 80. The section 84 may be configured to facilitate the entry and/or exit of the deployable devices 14 from storage area 80 of the vehicle 20 while the vehicle 20 is stopped at a scene, and/or when the vehicle 20 is in motion while approaching the scene or traveling along the road following the scene. For example, when the vehicle 20 is dispatched or otherwise responding to a scene, the operator may provide an input to the user interface component 49 commanding one or more deployable devices 14 to initiate deployment from the storage area 80 and establish a perimeter around the vehicle 20. In some embodiments, the deployable devices 14 are automatically deployed from the storage area 80 based on an indication (e.g., via location sensors, via environment sensors, etc.) that the vehicle 20 is approaching or has arrived at the scene. Additionally or alternatively, once the vehicle 20 has arrived at the scene, the operator may provide an input to the user interface component 49 commanding one or more deployable devices 14 to initiate deployment from the storage area 80 and establish a perimeter around the vehicle 20.

According to an exemplary embodiment in which the vehicle 20 does not include the rear assembly 54 or does not otherwise have capacity for the storage area 80, the storage area 80 may be configured as a trailer to be towed by the vehicle 20 or as a trunk of the vehicle 20. In such embodiments, one or more deployable devices 14 may be individually stored in a manually transportable carrier, suitcase, bin, case, etc. The transportable carrier may include a charger to recharge an energy storage device (e.g., battery) of the deployable device 14. The transportable carrier carrying the deployable device 14 may be placed on the road or near the vehicle 20 dispatched at the scene. The operator may manually unpack the deployable device 14 from the transportable carrier, or the deployable device 14 may be automatically released from the transportable carrier upon being unloaded from the storage area 80 or arriving at the scene.

### Deployable Devices

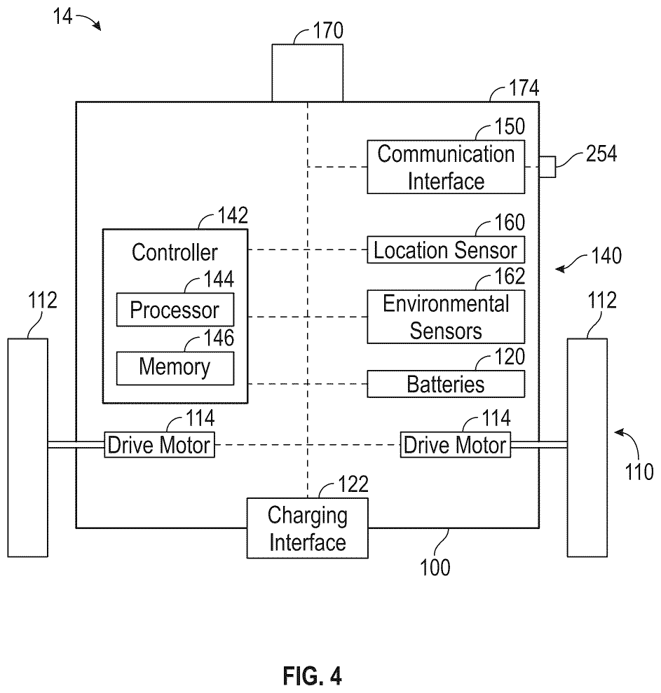

As shown in FIG. 4, the deployable device 14 includes a frame, housing, or chassis, shown as chassis 100, that supports the other components of the deployable device 14. The chassis 100 may include one or more components (e.g., frame members, housings, etc.) coupled to one another to form the chassis 100.

As shown in FIG. 4, the deployable device 14 includes a drivetrain, shown as propulsion system 110, configured to propel the deployable device 14. The propulsion system 110 includes one or more propulsive elements (e.g., tractive elements, etc.), shown as wheels 112, rotatably coupled to the chassis 100. The wheels 112 are configured to engage a support surface (e.g., the ground) to support the deployable device 14. The propulsion system 110 includes one or more actuators (e.g., electric motors), shown as drive motors 114, coupled to the chassis 100. Each drive motor 114 is coupled to one or more of the wheels 112 and configured to drive movement of one or more of the wheels 112. In some embodiments, a first drive motor 114 is coupled to the wheels 112 on a left side of the chassis 100, and a second drive motor 114 is coupled to the wheels 112 on a right side of the chassis 100. In such embodiments, the drive motors 114 can drive the wheels 112 on the left and right sides of the chassis 100 independently to facilitate steering of the deployable device 14.

As shown in FIG. 4, the deployable device 14 includes one or more energy storage devices, shown as batteries 120, coupled to the chassis 100. The batteries 120 may store energy to power the systems of the deployable device 14. The batteries 120 may be electrically coupled to one or more systems of the deployable device 14 (e.g., drive motors 114, warning device 170, etc.) to supply the stored electrical energy. In other embodiments, the deployable device 14 is otherwise powered, and the deployable device 14 includes a different type of energy storage device. By way of example, the deployable device 14 may be powered by a hydrogen fuel cell, and the energy storage device may be a tank of hydrogen. By way of another example, the deployable device 14 may be powered by an internal combustion engine, and the energy storage device may be a fuel tank.

As shown in FIG. 4, the deployable device 14 includes an energy transfer interface, shown as charging interface 122, coupled to the chassis 100. The charging interface 122 is configured to transfer electrical energy into and/or out of the deployable device 14 (e.g., between the deployable device 14 and the chargers of the storage area 80 or the chargers of the transportable carrier). The charging interface 122 may supply electrical energy to charge the batteries 120. In some embodiments, the charging interface 122 transfers energy wirelessly. In such embodiments, the charging interface 122 may include a wireless energy transfer coil to transfer energy through induction. In some embodiments, the charging interface 122 is configured to transfer electrical energy through a wired connection. In such embodiments, the charging interface 122 may include a set of electrical contacts positioned to engage a set of external electrical contacts.

As shown in FIG. 4, the deployable device 14 includes a control system 140 including a controller 142 that controls operation of the deployable device 14. The controller 142 is operatively coupled to the drive motor 114 and the warning device 170. The controller 142 includes a processing circuit, shown as processor 144, and a memory device, shown as memory 146. The memory 146 may contain one or more instructions that, when executed by the processor 144, cause the controller 142 to perform the processes described herein. The control system 140 may be communicably coupled with the control system 22 of the vehicle 20 (e.g., wirelessly via a network, Bluetooth™, near-field communication, etc.). While some processes may be described as being performed by the controller 142, it should be understood that those processes may be performed by any other controller of the system 10 (e.g., the controller 28, a control system remote from the deployable devices 14 and the vehicle 20) or distributed across multiple controllers of the system 10.

As shown in FIG. 4, the control system 140 includes a network interface, shown as communication interface 150, operatively coupled to the controller 142. The communication interface 150 is configured to transfer data between the deployable device 14 and other components of the system 10 (e.g., other deployable devices 14, the vehicle 20, the controller 28, etc.). The communication interface 150 may facilitate wired and/or wireless communication.

As shown in FIG. 4, the control system 140 includes various sensors (e.g., one or more position, velocity, acceleration, optical, proximity sensors, etc.), shown as location sensor 160 and environment sensor 162, operatively coupled with the controller 142 and positioned about the deployable device 14 to acquire deployable device information or deployable device data regarding operation of the deployable device 14 and/or the location thereof. The location sensor 160 is configured to facilitate detecting and obtaining location data relating to a location (e.g., position) of the deployable device 14. By way of example, the location sensor 160 may include a global positioning system (GPS) sensor configured to acquire information relating to the location of the deployable device 14. By way of another example, the location sensor 160 may include one or more accelerometers and/or gyroscopes that track movement of the deployable device 14. The controller 142 may utilize the location data to navigate to an intended (e.g., desired) position along a predetermined perimeter around the vehicle 20 or to navigate back to the vehicle 20 (e.g., responsive to receiving a signal indicative of the shutdown of the scene, that the deployable device 14 is low on fuel, etc.).

The environment sensors 162 are configured to facilitate detecting and obtaining environment data relating to the environment surrounding the deployable device 14. By way of example, the environment sensors 162 may include cameras, LiDAR sensors, light sensors, switches that detect contact with other objects, or other types of sensors that provide environment data. The controller 142 may utilize the environment data to identify objects in the surrounding environment and facilitate navigation. By way of example, the controller 142 may use the environment data to identify and avoid one or more obstacles in the surrounding environment (e.g., by controlling operation of the drive motor 114). By way of another example, the controller 142 may use the environment data to identify the predetermined perimeter around the vehicle 20 and travel to a particular location or spot along the perimeter. By way of another example, the controller 142 may use the environment data to identify and navigate along road markings on a street or other path.

As shown in FIG. 4, the deployable device 14 includes an indicator, a warning device, alert device, light system, sign, speaker, screen, etc., shown as warning device 170, operatively coupled to the controller 142. The warning device 170 is configured to enhance the visibility of the vehicle 20 to warn approaching, oncoming, and neighboring vehicles of the vehicle 20, the scene, or any other hazard to avoid. One or more warning devices 170 of one or more deployable devices 14 are configured collectively operate (e.g., coordinate operation) to provide an indication to other vehicles or pedestrians to stop, slow down, or merge while driving by and passing the vehicle 20 and/or the scene. In some embodiments, the vehicle 20 includes one or more warning devices 170 coupled to the cab 48, the front end 44, the rear end 46, the headboard 70, the storage area 80, or otherwise positioned about the vehicle 20.

As shown in FIG. 4, the warning device 170 is coupled to the deployable device 14 and positioned on top of the deployable device 14. By way of example, the warning device 170 may be positioned on an outwardly facing surface of the deployable device 14, or otherwise positioned about the deployable device 14 such that the warning device 170 and the indications (e.g., warnings, sounds, lights, visuals, etc.) produced by the warning device 170 are seen or heard by drivers of oncoming, approaching, or neighboring vehicles. In some embodiments, two or more warning devices 170 are coupled to a deployable device 14.

The warning device 170 may include a light system including a plurality of lights, beacons, or light bars configured to illuminate the scene and increase visibility of the vehicle 20 and/or the scene. By way of example, the light system may illuminate open travel lanes that pass through and/or adjacent to the scene. The light system may be selectively controllable to turn on and off, flash, and/or provide one or more dynamic light patterns. The lights of the light system may be the same color (e.g., yellow, etc.) or various colors (e.g., red, white, blue, etc.). By way of example, the light system may illuminate one or more lanes on the street that are open for approaching vehicles with a green light and/or project a symbol (e.g., an arrow, or another symbol indicative that the lane is open) on the open lane to indicate that the lane is an open lane. By way of another example, the light system may illuminate one or more lanes on the street that are closed to approaching vehicles with a red light and/or project a symbol (e.g., an “X”, or another symbol indicative that the lane is closed) on the closed lane to indicate that the lane is a closed lane. By way of yet another example, the light system may project white lines on the street to indicate the creation of new lanes in which the approaching vehicles may travel to avoid the scene.

The warning device 170 may include a screen (e.g., LED screen, etc.) configured to display a particular message, symbol, instruction to other vehicles. For example, the screen may provide a message indicating that there is road work ahead, the road is scheduled to close for a time period, or any other warning or informational message intended to inform other vehicles. By way of another example, the screen may display a symbol such as a left or right arrow indicating that other drivers should merge left or right to avoid the vehicle 20 or the scene.

The warning device 170 may include an indicator (e.g., that does not include lights, etc.). The indicator may be or include a flag, a sign, a bright or fluorescent color, etc. The indicator may be used or positioned to increase visibility of the vehicle 20, the scene, or the deployable device 14 during daytime operation. By way of example, the sign may be coupled to a portion of the deployable device 14 that provides textual indications (e.g., “Proceed with Caution,” “Move Over,” “Work Area,” “Slow,” “Road Work Ahead,” etc.) and/or visual indications (e.g., an arrow indicating to move over, a yield sign, a stop sign, a merge sign, etc.). The sign may also be bright or fluorescent colored to indicate a status of the vehicle 20 and/or the scene. By way of example, the sign may be yellow to provide an indication to other vehicles to slow down or proceed with caution, red to provide an indication to other vehicles to stop, etc. By way of another example, the warning device 170 and/or other components of the deployable device 14 may be painted or otherwise colored one of more fluorescent colors (e.g., yellow, green, etc.). In some embodiments, the flags, the signs, the warning device 170, and/or other components of the deployable device 14 are reflective or glow-in-the-dark to increase visibility of the vehicle 20 during nighttime operation.

The warning device 170 may include a traffic cone or traffic barrel. The traffic cone may be a bright or fluorescent color to increase visibility of the vehicle 20, the scene, or the deployable device 14 during operation. By way of example, the traffic cone may be constructed using a combination of durable materials capable of resisting harsh weather conditions and including high-visibility coatings (e.g., paintings, markings, etc.). The traffic cone may include a weighted component to maintain the traffic cone in an upright and visible position during operation and deployment of the deployable devices 14. The traffic cone may be configured as an inflatable device that selectively inflates in response to an indication that the deployable device 14 is deployed, or is otherwise in operation. The inflatable traffic cone facilitates compact and efficient storage of the deployable device 14 when not in use.

The warning device 170 is communicably coupled to the control system 140 of the deployable device 14 and is further configured to receive information, data, or commands from the controller 28 of the vehicle 20 and/or the controller 142 of the deployable device 14. By way of example, the controller 28 of the vehicle 20 may transmit information, data, or commands via the communication interface 24 to be received by the controller 142 of the deployable device 14 relating to a command for the warning device 170 to operate a certain way (e.g., deploy the warning device 170, emit a flashing light, display a message on a screen, etc.). Similarly, because each of the deployable devices 14 are communicably coupled to each other and to the vehicle 20 (e.g., directly, indirectly, etc.), the vehicle 20 may collectively coordinate the control of the plurality of warning devices 170 in a particular way, such as to cause each of the warning devices 170 to selectively emit light via the lighting system in a sequential manner, in a pattern, in an alternating fashion, or otherwise. In some embodiments, the controller 28 or controller 142 may cause the warning device 170 (e.g., the light system) of each deployable device 14 to selectively emit light based on a position of the deployable device 14 relative to the vehicle 20 such that the light system of the warning device 170 may emit light according to a pattern. By way of example, the pattern may be a sequential pattern whereby warning device 170 of the deployable device 14 nearest to the vehicle 20 illuminates first, followed by the next nearest warning device 170 of the deployable device 14, etc. until the farthest warning device 170 of the deployable device 14 illuminates or vice versa. Such patterns provided by the warning devices 170 may also be coordinated with the warning device 170 of the vehicle 20 (e.g., by the controller 28, by the controller 142, by a remote command center/server, etc.) such that all of the warning devices 170 on scene are coordinated to provide a comprehensive and coordinated scene lighting system.

As shown in FIG. 4, the deployable device 14 includes a deployment mechanism, support, stage, actuatable platform, etc., shown as platform 174, configured to support the warning device 170 of the deployable device 14. The platform 174 may be positioned near the top surface of the deployable device 14 and configured to selectively actuate (e.g., move, reposition, etc.) the warning device 170 between a stored position and a deployed position. In the stored position, the warning device 170 may be entirely or at least partially housed by (e.g., received within) the deployable device 14. In the deployed position, the warning device 170 may be sufficiently visible to warn other drivers (e.g., provide an indication to other vehicles) of the presence of the vehicle 20, the scene, and/or the deployable device 14. The platform 174 may be actuated by any one or more of a hydraulic actuator (e.g., hydraulic cylinder, hydraulic motor, etc.), a pneumatic actuator (e.g., pneumatic cylinder, pneumatic motor, etc.), and/or an electrical actuator (e.g., electrical motor, electric linear actuator, etc.). The platform 174 is communicably coupled to the control system 140 and may be deployed responsive to receiving a command (e.g., a signal) from the controller 28 and/or the controller 142. Additionally or alternatively, the platform 174 may be manually actuated between the stored position and the deployed position by an operator before or as the deployable devices 14 are deployed around the vehicle 20. In some embodiments, when the deployable device 14 is deployed from the vehicle 20 or storage area 80, the operator manually places the warning device 170 on the platform 174.

### Coordinated Control

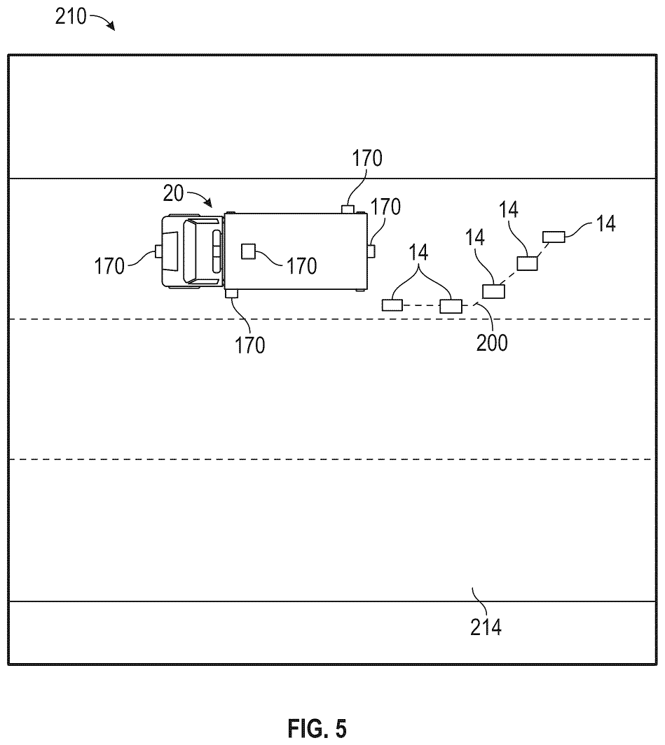

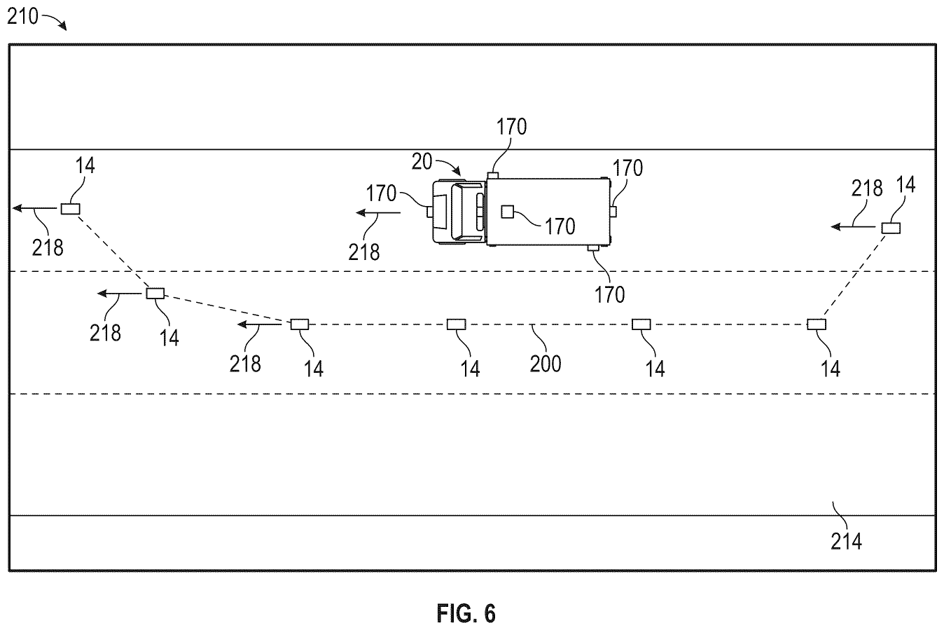

According to an exemplary embodiment shown in FIGS. 5 and 6, the deployable devices 14 are configured to deploy to establish a perimeter 200 (e.g., boundary, blockade, line, etc.) proximate the vehicle 20 when dispatched at a scene 210 (e.g., construction site, emergency scene, motor-vehicle accident, car breakdown, traffic stop, road hazard, the vehicle 20 and deployable devices 14, etc.). In some embodiments, the scene 210 is an area (e.g., a zone, a one mile radius, a two mile radius, the municipality in which the hazard is located, etc.) surrounding the hazard, the deployable devices 14, and the vehicle 20. The scene 210 may be located near a street 214, in the middle of the street 214, or any other location where an emergency vehicle, tow vehicle, construction vehicle, or any other vehicle may be dispatched. The streets 214 may be designated (e.g., by a municipality or other organization) for use as a road, street, highway, bicycle path, sidewalk, etc. Accordingly, the streets 214 may be shared between the vehicle 20, the deployable devices 14 and cars, trucks, bicycles, pedestrians, or other types of traffic.

In operation, the deployable devices 14 may be initially stationed on chargers of the storage area 80 of the vehicle 20, or otherwise transported and stored by the vehicle 20. When the vehicle 20 is dispatched to the scene 210, the controller 28 is configured to initiate (e.g., automatically initiate responsive to a signal received from the location sensor 160 or the environmental sensor 162 indicating that the vehicle 20 has arrived at the scene 210) a deploy protocol to deploy the deployable devices 14 at the scene 210. In some embodiments, the controller 28 initiates the deploy protocol responsive to a signal received from the location sensor 160 or the environmental sensor 162 indicating that the vehicle 20 has arrived at or is approaching the scene 210. In other embodiments, the operator of the vehicle 20 provides an input to the user interface component 49 to initiate the deploy protocol (e.g., command the controller 28 to initiate the deploy protocol).

Responsive to an initiation of the deploy protocol, the deployable devices 14 deploy from the vehicle 20, the storage area 80, transportable carrier, etc. and collectively coordinate movement around the vehicle 20 or the scene 210 to establish the perimeter 200. In some embodiments, responsive to the initiation of the deploy protocol, the deployable devices 14 travel from the vehicle 20 to various positions (e.g., assigned positions) along the perimeter 200 that is predetermined to establish a barrier, warning, indication, etc. to oncoming and approaching vehicles. In some embodiments, the deploy protocol is initiated (e.g., the deployable devices 14 travel to various positions along the perimeter 200) before the operator has exited the cab 48 of the vehicle 20. Each deployable device 14 may be controlled and programmed to travel along the perimeter 200 to a particular location and orientation along the perimeter 200. By way of example, the deployable device 14 that is deployed first may travel to a location on the perimeter 200 that is the furthest away from the vehicle 20, the deployable device 14 that is deployed second may travel to a location on the perimeter 200 that is the second furthest away from the vehicle 20, etc. In embodiments where the warning devices 170 between different deployable devices 14 are different types (e.g., signs, lights, flags, etc.), the deployable devices 14 having the same or similar warning devices 170 may be grouped (e.g., sequentially located, positioned adjacent to each other, etc.) along the perimeter 200. By way of example, a first deployable device 14 having a warning device 170 of a first type (e.g., a sign) may be designated to travel to a location on the perimeter 200 where the warning device 170 is easily visible and identifiable by other vehicles. Further, a second deployable device 14 having a warning device 170 of a second type (e.g., light) may be designated to group on the perimeter 200 with other deployable devices 14 also having a warning device 170 of the second type (e.g., a light). In some embodiments, each deployable device 14 travels to a respective location on the perimeter 200 by traveling on the shortest path to reach the respective location (e.g., in a straight line).

As shown in FIGS. 5 and 6, the perimeter 200 is a track, path, boundary, etc. around the vehicle 20 and/or scene 210. In some embodiments, the perimeter 200 is a virtual boundary established by a plurality of deployable devices 14. The perimeter 200 may entirely encircle, partially encircle, or define a portion along a front, back, and/or side of the vehicle 20 and/or the scene 210. The predetermined perimeter may be based on one or more of a plurality of predetermined perimeters by the controller 28. In some embodiments, the operator selects one of the predetermined perimeters. In other embodiments, the controller 28 automatically selects a predetermined perimeter based on one or more aspects of the scene 210, the vehicle 20, or the deployable devices 10. The plurality of predetermined perimeters may include perimeters of different shapes, of different distances to/from the vehicle 20, of different numbers of assigned positions, of different types (i.e., emergency site, construction site, etc.), of different severities (i.e., safe, dangerous, etc.), for different types of vehicle 20 (e.g., firefighting vehicle, refuse truck, etc.) or other perimeters. By way of example, the perimeter 200 may be predetermined based on the nature of the scene 210. In a case where the vehicle 20 is dispatched to a scene 210 where a portion of a lane of the street 214 is closed (e.g., for roadwork, an emergency scene, etc.), the perimeter 200 may be shaped to diagonally extend in a direction behind the vehicle 20 from the rear end 46 of the vehicle 20. The diagonally extending perimeter 200 (e.g. along which deployable devices 14 are deployed) may provide an indication to approaching vehicles that the lane of the street 214 is closed and that the approaching vehicle should merge to an open/unclosed lane. The perimeter 200 may be predetermined based on the state of the vehicle 20. By way of example, the vehicle 20 may be pulled over (e.g., parked) onto the side of the street 214, in which case, the perimeter 200 may be defined by a line extending behind the vehicle 20 to provide forewarning of the vehicle 20 to approaching vehicles.

In some embodiments, the perimeter 200 is established based on the information acquired by the location sensors 160, the environment sensors 162, or any other sensor utilized by the deployable devices 14 or the vehicle 20 when the deployable devices 14 are deployed at the scene 210. By way of example, the controller 142 may utilize the location data collected by the location sensor 160 to establish the perimeter 200 based on GPS coordinates, geographical landmarks, or any other location data. By way of another example, the controller 142 may use the environment data collected by the environment sensor 162 to establish the perimeter 200 around the vehicle 20 based on road signs, mile markers, the curvature of the street 214, markings painted on the street 214, detection of the scene 210, or any other environment data. The deployable devices 14 receive a signal (e.g., from the control system 22, from the controller 142, etc.) relating to the establishment of the perimeter 200 and a command to navigate to a respective (e.g., desired, programmed, commanded, intended, etc.) position on the perimeter 200 around the vehicle 20 or follow the perimeter 200 to navigate back to the vehicle 20.

In some embodiments, the perimeter 200 is manually created (e.g., established, defined, drawn, mapped, determined, set, programmed, etc.) by the operator. By way of example, the operator provide a desired path (e.g., via an input to the user interface component 49) along which the deployable devices 14 are to be spaced and deployed. The operator defined perimeter 200 may be a unique path, along which the deployable devices 14 are deployed, that is established (e.g., mapped) to provide a barrier between the operator of the vehicle 20 and any other individuals near the scene 210 and other vehicles, or otherwise warn oncoming, approaching, and neighboring vehicles of the vehicle 20 and the scene 210. In other embodiments, the perimeter is manually selected from a plurality of predetermined preexisting perimeters by the operator.

The deployable devices 14 may coordinate movement with each other to follow the vehicle 20 as the vehicle 20 moves in a direction 218 along the street 214. By way of example, when the scene 210 is a construction site where the road is being paved, the vehicle 20 may follow the construction site (e.g., the scene 210) as it progresses in the direction 218 along the street 214. In some embodiments, the deployable devices 14 coordinate movement with each other and/or the vehicle 20 to follow the vehicle 20 as the vehicle 20 moves in any direction along, near, adjacent to, etc. the street 214. The speed of the vehicle 20 following the scene 210 may be slow enough relative to the speeds of the deployable devices 14 to facilitate generally maintaining the perimeter 200 established by the deployable devices 14 without the deployable devices 14 falling behind the vehicle 20 and/or the scene 210. In some embodiments, the perimeter 200 around the vehicle 20 and/or scene 210 is dynamic and changes shapes, lengths, sizes, etc. as the vehicle 20 and scene 210 move. The dynamic perimeter 200 facilitates maintaining a visible series of deployable devices 14 while the vehicle 20 and/or scene 210 moves (e.g., curvature of the street 214 changes, the state of the vehicle 20 changes, the scene 210 changes, etc.). In some embodiments, the (i) deployment of the deployable devices 14 from the vehicle 20 along the perimeter 200 and (ii) return of the deployable devices 14 to the vehicle 20 for storage in the storage area 80 are scheduled in coordination with the scheduled hours of work at the scene 210. By way of example, the deployable devices 14 may be deployed to establish the perimeter 200 when the work (e.g., hooking up a disabled vehicle to the vehicle 20, construction, etc.) at the scene 210 begins (e.g., when the first of the personnel/workers arrive at the scene 210) for the day, and may return to storage in the storage area 80 when the work has concluded (e.g., when all personnel/workers have left the scene) for the day.

In some embodiments, the deployable devices 14 are evenly spaced along the perimeter 200. By way of example, the deployable devices 14 may be spaced a substantially equal distance from adjacent deployable devices 14 along the perimeter 200. Additionally or alternatively, the spacing between the deployable devices 14 deployed along the perimeter 200 may be nonlinear. By way of example, the spacing of the deployable devices 14 may be more concentrated along a portion of the perimeter 200 that is the most visible to approaching vehicles. In general, a higher concentration of the deployable devices 14 along a portion of the perimeter 200 that is the most visible to approaching vehicles helps to increase the visibility of the vehicle 20 and/or the scene 210.

As shown in FIG. 1, the vehicle 20 includes a coordinated control system 230. In some embodiments, the communication interface 24 and the controller 28 of the vehicle 20 operate as the coordinated control system 230. The coordinated control system 230 is configured to monitor the position, status, control, etc. of one or more deployable devices 14. By way of example, the coordinated control system 230 may monitor and store information relative for determining movement controls for one or more deployable devices 14 deployed at the scene 210 around the vehicle 20 and/or the vehicle 20 itself. The coordinated control system 230 may record movement controls for the current session (e.g., task, deployment, etc.) of the deployable devices 14 and save the movement controls to a local or remote memory (e.g., the memory 146). In some embodiments, the coordinated control system 230 monitors and records the previous movement controls of one or more deployable devices 14 for a given task associated with a particular location, scene type (e.g., emergency scene, construction site, etc.), operator, and/or proximity to other deployable devices 14 or vehicles 20 at the scene 210.

In some embodiments, movement controls include a real-time movement command, wherein movement controls are reported based on the immediate (e.g., most recent) status of the deployable device 14, condition, and/or criteria at the time of movement controls are requested from the coordinated control system 230. In some embodiments, movement controls may include movement data over a period of time or particular operation selected by the operator. By way of example, the operator may generate and/or request a real-time movement report using a mobile application and the coordinated control system 230 may be configured to generate the movement report stored within the movement control information.

As shown in FIG. 1, the vehicle 20 includes an equipment identification system 250 that facilitates communication between the communication interface 150 of the deployable devices 14, the communication interface 24 of the vehicle 20, and other elements connected to the equipment identification system 250. The communication interface 150 may exchange commands and data with the controller 142 of the deployable device 14, sensor data with the location sensor 160 and the environment sensor 162, machine data with other deployable devices 14, commands and data with the controller 28 of the vehicle 20, and commands and data with the user interface component 49 running an application for the equipment identification system 250. The equipment identification system 250 may exchange commands, codes, and data between deployable devices 14 and/or the vehicle 20 to form a network of interconnections among the deployable devices 14, the vehicle 20, and/or any other systems or machines dispatched at the scene 210.

By way of example, in response to an operator selection on an application hosted on the user interface component 49, one or more deployable devices 14 can be located and/or identified by one or both of a visual or audible signal from the selected deployable device 14 or from the communication interface 150 coupled to the deployable device 14. By way of example, the communication interface 150 may also include an indicator, shown as beacon 254, that may include one or both of a light or sound generator and may be configured to identify a machine by generating one or both of a visual or audible signal (e.g. alerts, indications, etc.). The communication interface 150 may, for example, include a beacon 254 that includes a light (e.g., an RGB LED light) which is lit when an operator presses a button on an application (e.g. an identify-my-machine application on the user interface component 49). Additionally or alternatively, the communication interface 150 may be communicably coupled to one or more lights (e.g., headlights, cabin lights, etc.) included in the warning device 170 of the deployable device 14 and can instruct the lights to generate the visible signals in response to the selection of a button on the user interface component 49. The beacon 254 may additionally or alternatively include a speaker to provide the audible signals. Additionally or alternatively, the communication interface 150 may be communicably coupled to a horn of the deployable device 14 (e.g., via the control system 140) and can instruct the horn to sound to generate an audible signal in response to the selection of a button on the user interface component 49. The visual and audible signals can be used in conjunction or independently of one another. The beacon 254 may emit any or all combinations of frequency, color, patterns etc. of light and may emit any sound or message (e.g., recorded or computer generated speech). The communication interface 150 may be a self-contained unit. For example, the communication interface 150 may be installed on or connected to deployable devices 14 not configured by the original product manufacturer with a communication interface 150 and may be configured to communicate with the control system 140 of the deployable device 14.

The equipment identification system 250 may, for example, dynamically filter a user interface map to illustrate a total population of the deployable devices 14 connected to the equipment identification system 250. In a further example, a remote user may apply a filter to a specific work site network, much the same as can be done locally, via a mobile application. This facilitates a remote user to apply desired user configurable rules to assist a local user that does not have access to a user interface of the equipment identification system 250. In some embodiments, the beacon 254 includes a light that may be used to illustrate or illuminate statuses of various deployable devices 14 (e.g. fuel level, battery level, maintenance status, ignition on/off, in operation, etc.). By way of example, the light on the beacon 254 may be green when the fuel level is high and red when the fuel level is low. An application on the user interface component 49 can be used as an interface for an operator to select which status they want to be displayed on a fleet of deployable devices 14 within the connected range (e.g., along the perimeter 200, distance, selected area, etc.) of the vehicle 20. The operator may selectively command the beacons 254 of one or more deployable devices 14 within the selected range to indicate the status or condition of the associated deployable device 14. By way of example, the operator may select an option that turns the light green on deployable devices 14 that are to be deployed at the scene 210 and turns the light red on deployable devices 14 that are not to be deployed at the scene 210. In some examples, selections are independent of or in conjunction with the filter criteria of a desired subset of deployable devices 14. In some embodiments, the user interface component 49 is configured to send a command to the communication interface 150 of a selected deployable device 14 to power up or power down the deployable device 14. In some embodiments, the user interface component 49 is configured to send a command the communication interface 150 of one or more deployable devices 14 to command the one or more deployable devices 14 to return to the vehicle 20 upon a shutdown of the scene 210 (e.g., an emergency scene has been cleared, construction has finished, roadwork has finished, an obstacle has been cleared, etc.). In some embodiments, the user interface component 49 is configured to send a command to the communication interface 150 of a selected deployable device 14 to enable or disable operation of the deployable device 14.

In some embodiments, in addition to coordinating control of the movement of the deployable devices 14, the operation of the warning devices 170, and any other component included in the system 10, the control system 22 and/or the control system 140 are communicably coupled over a network to other assets (e.g., signs, cones, lights, etc.) located along the street 214 (e.g., in a direction up/down the street 214 from the scene 210) or located within an area surrounding the scene 210 (e.g., within a one mile radius of the scene 210, within a two mile radius of the scene 210, within the municipality in which the scene 210 is located, etc.). By way of example, the control system 22 and/or the control system 140 may control the operation of one or more signs (e.g., digital signs, etc.) located in a direction up/down the street 214 to display a message (e.g., “Road Work Ahead,” “Merge Left,” “Merge Right,” “Slow Down,” etc.) or an indication (e.g., an arrow, a flashing light, etc.) to alert or otherwise warn other vehicles that they are approaching the vehicle 20 and the scene 210. By way of another example, the control system 22 and/or the control system 140 may control the operation of stop-and-go lights in the area surrounding the scene 210 to control and direct the flow of traffic around (e.g., away from) the scene 210.

In some embodiments, the scene 210 is a zone (e.g., an area, a predetermined subject area, a perimeter, a virtual boundary, etc.) surrounding the hazard, the deployable devices 14, and the vehicle 20. The zone may be predetermined based on the location of the hazard, the deployable devices 14, and/or the vehicle 20. By way of example, the zone may be established as a predefined area (e.g., a one mile radius, a two mile radius, one or more lanes of the street 214, etc.) around the hazard, the deployable devices 14, and/or the vehicle 20, or the zone may be established as the municipality in which the hazard, the deployable devices 14, and/or the vehicle 20 is located. By way of another example, the zone may be manually created (e.g., defined, drawn, mapped, determined, set, programmed, etc.) by the operator. The operator may input a desired boundary (e.g., into the user interface component 49) defining the area of the zone. In such an embodiment, the communication interface 24 and/or communication interface 150 is configured to facilitate wireless communication between the vehicle 20, the deployable devices 14, other assets, and/or other vehicles. The other assets and/or vehicles may be any one or more of a construction vehicle, emergency vehicle, a target, or any other asset/vehicle associated with, located at, responding to, or passing through the scene 210.

The controller 28 and/or the controller 142 may be configured to transmit commands, data, or information to one or more of the other assets/vehicles upon a determination that the other assets/vehicles have entered the zone. The commands, data, or information transmitted upon entering the zone may be associated with a warning (e.g., alert, notification, indication, message, etc.) that other assets/vehicles have entered the zone. By way of example, responsive to entering the zone, the other assets and/or vehicles may receive (e.g., via a communication interface) a signal from the communication interface 24 of the vehicle 20 commanding a user interface component of the other assets and/or vehicles to provide a warning (e.g., notification, indication, message, visual cue, sound, audible announcement, etc.) indicating that they have entered the zone and are approaching the vehicle 20 and/or the scene 210. In some embodiments, the signal transmitted from the communication interface 24 of the vehicle 20 associated with the warning indicating that the other assets/vehicles are entering the zone is adjusted (e.g., modified, different, personalized, etc.) depending on the state of the other assets/vehicles and/or the type of the street 214. By way of example, the location sensor 160 and/or environment sensor 162 may acquire data relating to the other assets/vehicles to determine a direction of travel of the other assets/vehicles. Responsive to a determination that the other assets/vehicles are traveling on the same side of the street 214 as where the scene 210 is located, the warning may indicate to the driver that they are approaching a scene (e.g., scene 210) located on their side of the street 214. Conversely, responsive a determination that the other assets/vehicles are traveling on the opposite side of the street 214 compared to where the scene 210 is located, the warning may indicate to the driver that they are approaching a scene (e.g., scene 210) located on the opposite side of the street 214. By way of another example, the warning indicating that the other assets/vehicles are entering the zone is adjusted based on the type of the street 214 (e.g., divided highway versus non-divided highway, rural road versus urban road, etc.).

The control system 22 and/or the control system 140 may determine whether the other assets/vehicles have entered the zone based on a signal received from the other assets and/or vehicles relating to the positioning and location of the of the other assets/vehicles. By way of example, the control system 22 and/or the control system 140 may include a GPS receiver configured to receive data relating to GPS coordinates, velocity, direction, or any other positional data of the other assets/vehicles. In some embodiments, the location sensors 160 and environment sensors 162 may acquire information about the other assets/vehicles having entered the zone and transmit a signal relating to the information to the control system 22 and/or the control system 140. In some embodiments, the other assets/vehicles include one or more sensors (e.g., cameras, LiDAR sensors, or other types of sensors that provide environment data) that acquire data relating to the surroundings of the other assets/vehicles, such as detecting the deployable devices 14, the vehicle 20, the scene 210, and/or any other environmental objects. The other assets/vehicles may transmit a signal relating to the acquired data to the control system 22 and/or the control system 140. The control system 22 and/or the control system 140 may then analyze the signal to determine whether the other assets/vehicles have entered the zone. The control system 22 and/or the control system 140 may use substantially similar methods to determine whether the other assets/vehicles have exited the zone.

### Deployable Device Embodiments

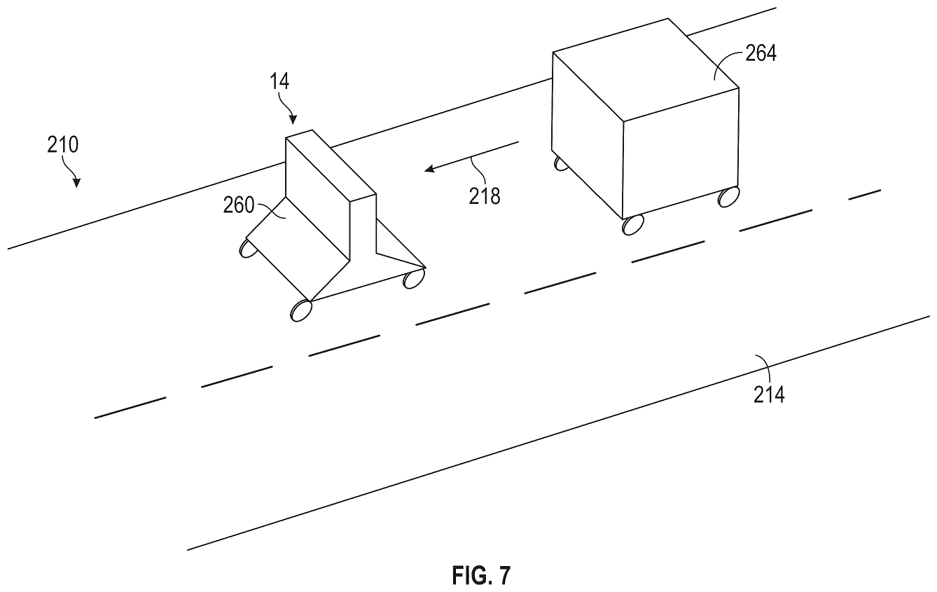

As shown in FIG. 7, a body 260 of the deployable device 14 may be configured as a barrier, blocker, bollard, etc. In such a configuration, the deployable device 14 is configured to stop (e.g., redirect, absorb, prevent, etc.) an oncoming, approaching, and/or neighboring vehicle 264 from crashing into (e.g., impacting, colliding with, etc.) the vehicle 20 and/or the scene 210. With the body 260 configured as a barrier, the deployable device 14 is coordinated and controlled in a similar manner as the deployable devices 14 described in greater detail above. As shown in FIG. 7, the body 260 may be shaped as an inverted “T” (e.g., jersey barrier, K-rail) having a profile defining a low slope face and a high slope face. In some embodiments, the body 260 is a different type of barrier or bollard having a different shape. The body 260 may be manufactured from concrete, reinforced concrete, high-strength polymers, composite materials, or any other high strength and durable material capable of withstanding repeated damage from other vehicles 264. In general, the body 260 is shaped and sized to redirect and/or stop an oncoming, approaching, or neighboring vehicle 264 from hitting the vehicle 20 and entering the scene 210. Redirecting and stopping other vehicles 264 may help facilitate protecting the operator of the vehicle 20 and any workers, pedestrians, or people near the scene 210 from being hit by the vehicle 264. Upon impact from another vehicle 264, the body 260 and the deployable device 14 are configured to absorb the impact energy of the vehicle 264 and gradually dissipate the kinetic energy by rolling on the wheels 112 for a short distance. Rolling on the wheels 112 for a distance helps reduce the force exerted on the vehicle 264 and any occupants therewithin. After impact, the body 260 may be configured to be knocked off the wheels 112 or a suspension of the deployable device 14 such that the body 260 is in direct contact with the street 214 to help absorb the impact of the vehicle 264 and redirect and/or bring the vehicle 264 to a stop. The body 260 may be configured to deform, collapse, or otherwise compress in a controlled manner to further dissipate the kinetic energy.

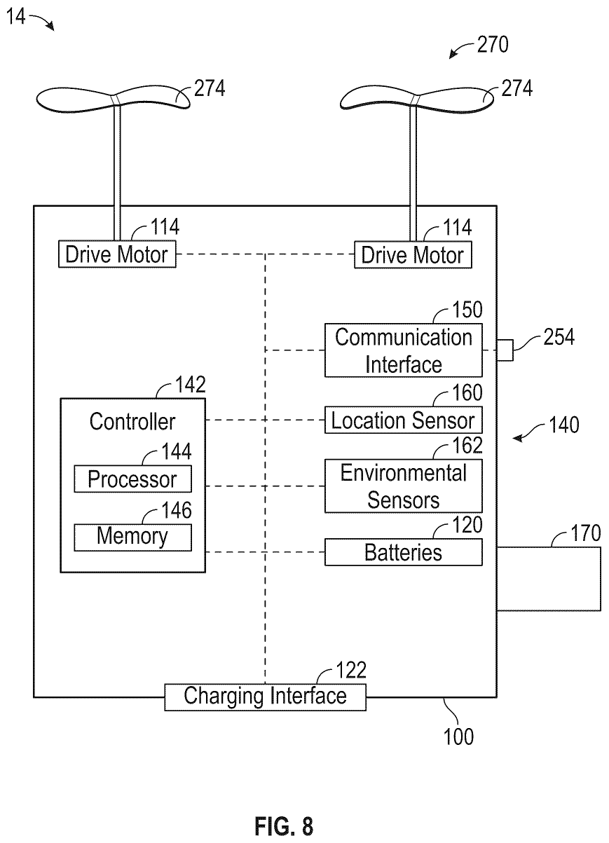

According to an exemplary embodiment shown in FIG. 8, the deployable device 14 is configured as an aerial drone (e.g., an unmanned aerial vehicle (UAV), a multi-rotor, a quadcopter, etc.), shown as aerial deployable device 270. In such embodiments, the aerial deployable device 270 includes substantially the same components and operates substantially similarly as the ground vehicle embodiment of the deployable device 14 as described in greater detail above, and further includes one or more propulsive elements (e.g., propellers, props, blades, etc.), shown as rotors 274, rotatably coupled to the chassis 100. Each drive motor 114 is coupled to one or more rotors 274 and configured to drive rotational movement of the rotors 274 to generate the necessary thrust to lift the aerial deployable device 270. The number of drive motors 114 and rotors 274 varies depending on (i) the application of the aerial deployable device 270, (ii) the weight of the aerial deployable device 270, and (ii) the weight of the load carried by the aerial deployable device 270. The drive motors 114 can drive each of the rotors 274 independently to facilitate hovering, forward/backward movement, left/right movement, vertical movement, and rotational (e.g., roll, pitch, yaw) movement.

In addition to including one or more warning devices 170 coupled to the chassis 100, the aerial deployable device 270 can carry the warning device 170 while flying. By way of example, the warning device may be coupled to the bottom of the aerial deployable device 270 via a rope, chain, bucket, arm, or some other extension member. The warning device 170 coupled to the aerial deployable device 270 may operate substantially similarly as described above.

The control system 140 controls operation of the aerial deployable device 270. The control system 22 may be configured to wirelessly transmit commands, data, or information to the control system 140 relating to the location, vector, and/or orientation of the vehicle 20 and/or scene 210 relative to the aerial deployable device 270. The control system 22 may further transmit a signal to the control system 140 relating to flight control commands (e.g., to change the position of the aerial deployable device 270 relative to the vehicle 20, the scene 210, and/or other aerial deployable devices 270). The controller 142 may be configured to analyze data gathered from the location sensor 160 and/or the environment sensor 162 to determine a travel path (e.g., a flight path of the aerial deployable device 270) and transmit commands based on the data to avoid collisions and hazards in the air (e.g., other aerial deployable devices 270, trees, power lines, birds, etc.) and/or on the ground (e.g., deployable devices 14, the vehicle 20, the scene 210, etc.). In some embodiments, the aerial deployable device 270 is manually controlled by the operator of the vehicle 20 or by a remote pilot.

The aerial deployable devices 270 are cooperatively coordinated to establish the perimeter 200 proximate the vehicle and/or scene 210. In some embodiments, in response to a request to initiate a deploy protocol, the aerial deployable devices 270 travel from the vehicle 20 to various positions along the perimeter 200. In some embodiments, the perimeter 200 is offset a distance from the ground to provide flight clearance above the ground such that the aerial deployable devices 270 are positioned along the perimeter 200 while flying (e.g., hovering) in the air. The aerial deployable devices 270 positioned along the perimeter 200 offset from the ground provides drivers of oncoming, approaching, and neighboring vehicles forewarning of the vehicle 20, the scene 210, and any other people/assets/vehicles near the scene 210. In some embodiments, the aerial deployable devices 270 are controlled and positioned in the air near (e.g., above, around, etc.) the vehicle 20 and/or the scene 210 to establish a perimeter 200 that is multi-dimensional (e.g., a three-dimensional array, etc.). By way of example, the aerial deployable devices 270 may be collectively controlled to form a wall (e.g., a five-by-five grid of aerial deployable devices 270, a ten-by-ten grid of aerial deployable devices 270, etc.). By way of another example, the aerial deployable devices 270 may be collectively controlled to form a dome that partially or entirely covers the vehicle 20 and/or the scene 210. By way of another example, the aerial deployable devices 270 may be collectively controlled to form the shape of a symbol (e.g., an arrow, a stop sign, a yield sign, etc.). By way of another example, the aerial deployable devices 270 may be collectively controlled to form a message (e.g., “Merge,” “Stop,” “Slow Down,” etc.) to warn other vehicles of the vehicle 20 and/or scene 210.

While the aerial deployable device 270 may travel by air, the aerial deployable device 270 may include the wheels 112 rotatably coupled to the chassis 100 and driven by the drive motor 114. The drive motor 114 may be configured to drive movement of one or more of the wheels 112 in response to a signal received by the control system 140 commanding the propulsion system 110 to drive (e.g., on the ground) the aerial deployable device 270 to a takeoff location (e.g., a location around the vehicle 20 and/or the scene 210). In some embodiments, the takeoff location is a location that has been determined (e.g., via the control system 22, via the control system 140, etc.) to be a safe spot for the aerial deployable device 270 to takeoff (e.g., start flying) and/or land (e.g., stop flying). Additionally or alternatively, in other embodiments, the takeoff location is a location from which the aerial deployable device 270 can start flying to reach a designated (e.g., programmed, desired, etc.) position (e.g., along the perimeter 200, in the tree-dimensional array, etc.) in the most efficient manner.

### Method of Deploying the Deployable Devices

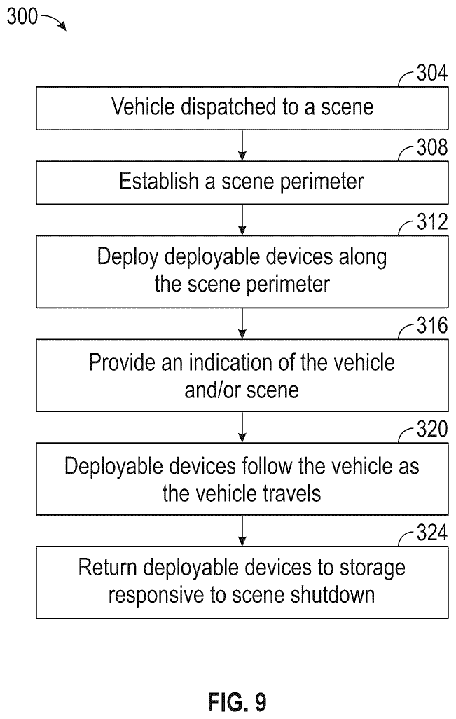

FIG. 9 illustrates a method 300 of deploying deployable devices (e.g., the deployable devices 14) to establish a perimeter (e.g., the perimeter 200) around a vehicle (e.g., the vehicle 20) or a scene (e.g., the scene 210). The method 300 includes steps 304-324, according to some embodiments. The method 300 or portions thereof may be performed by the controller 28 and/or the controller 114 to deploy the deployable devices.

At step 304, the vehicle is dispatched to and arrives at a scene. The scene may be an emergency scene, a construction site, a road closure, or any other form of hazard that drivers of oncoming, approaching, and neighboring vehicles should be aware of. The scene may be located on or next to a road (e.g., street 214), highway, sidewalk, path, etc. Upon being dispatched, the vehicle transports one or more deployable devices to the scene in a storage area (e.g., storage area 80).

At step 308, a perimeter is established (e.g., determined, programmed, mapped, etc.) around the vehicle dispatched to the scene, or is established around the scene. The perimeter may completely or partially surround the vehicle and/or scene. By way of example, the perimeter may entirely encircle the vehicle and the scene. By way of another example, the perimeter may be established along any side, front, and/or rear of the vehicle. The perimeter may be manually established by an operator of the vehicle, or may be automatically determined based on location data and/or environmental data collected from location sensors (e.g., location sensor 160) and environment sensors (e.g., environment sensor 162) of the vehicle or deployable devices.

At step 312, the deployable devices are deployed and spaced along the perimeter established at step 308. The deployable devices deploy from the storage area of the vehicle and are communicably coupled with one another and with the vehicle to coordinate the movement and travel to particular locations along the perimeter. Communication between the deployable devices and the vehicle forms a meshed network of interconnections between the deployable devices. The vehicle may transmit commands, information, and other data to the deployable devices relating to the travel coordination, spacing, and location of the deployable devices along the perimeter.

At step 316, the deployable devices coordinate warning signals from warning devices (e.g., warning devices 170). The warning signals enhance the visibility of the vehicle and the scene to divers of oncoming, approaching, and neighboring vehicles. The warning devices may be any one or more of a light, speaker, sign, traffic cone, screen, flag, etc. Further, the warning signals may provide an indication to the other vehicles indicating that the other vehicles should merge, slow down, or stop. The warning devices are communicably coupled with the deployable devices and with the vehicle, and are controlled based on a position of the deployable device to provide forewarning of the vehicle and the scene to other vehicles.

At step 320, the deployable devices may follow the vehicle as the vehicle moves. In an example where the scene moves along the road (e.g., paving a road, towing a vehicle, etc.), the vehicle and the deployable devices will follow while maintaining the positions of the deployable device along the perimeter, as the vehicle moves along the road behind, next to, or in front of the scene. In some embodiments, the vehicle and/or the scene are stationary such that after being deployed along the perimeter, the deployable devices remain stationary. Accordingly, in some embodiments, step 320 is skipped (e.g., the method 300 proceeds to step 324 after step 316).

At step 324, the deployable devices return from their positions along the perimeter to the storage area of the vehicle. The deployable devices may return responsive to receiving a signal (e.g., responsive to an input from the operator to the user interface component 49) commanding the deployable devices to return to the vehicle. In some embodiments, the location sensor and/or environment sensor detect that the scene has been shut down and provide a signal commanding the deployable devices to return to the vehicle.

### Advantages Over Other Systems

The system 10 of the present disclosure provides various advantages over other hazard warning systems. Other hazard warning systems require the operator of the vehicle to manually place warning devices (e.g., cones, signs, flags, etc.) along the side of the road upon arriving at a scene to establish a visible perimeter around the vehicle and the scene. Manually walking to set up the warning devices is extremely dangerous for the operator on busy highways, freeways, roads, and intersections with heavy traffic and fast moving vehicles. By automatically coordinating the deployable devices 14 to establish the perimeter 200 of warning devices 170 visible to other vehicles, the operator of the vehicle 20 does not have to walk along the street 214 and is in a safer position in the cab 48 of the vehicle 20. Further, in cases where the scene is a construction site or road work site that requires one or more lanes of a road to be closed, other hazard warning systems require that the entirety of the length of the lane of the road that is to be worked on is closed. The system 10 of the present disclosure eliminates the need to close down the entire lane because the deployable devices 14 are configured to move with the vehicle 20 and the scene 210 as they progress down the street 214. This reduces the length of the street 214 that needs to be closed at traditional construction/road work sites where traffic cones/barriers are placed along the entirety of the road that is to be worked on. Therefore, the system 10 of the present disclosure improves the flow of traffic because only portions of the street 214 that are being worked on and that need to be closed are blocked off by the deployable devices 14 and the vehicle 20.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A deployable device system comprising:
a deployable device including:
a propulsive element coupled to the deployable device;
a motor coupled to the deployable device and the propulsive element and configured to drive the propulsive element to propel the deployable device; and
an indicator configured to provide one or more indications to an operator of an approaching vehicle;
a vehicle configured to transport the deployable device to a scene and deploy the deployable device; and
a control system configured to:
control the motor to position the deployable device at a position along a perimeter established proximate the scene; and
control the indicator to provide an indication.

2. The deployable device system of claim 1, wherein the control system includes one or more processing circuits including at least one of (i) a first processing circuit located on the deployable device, (ii) a second processing circuit located on the vehicle, or (iii) a third processing circuit located remote from the deployable device and the vehicle.

3. The deployable device system of claim 1, wherein the indicator is a first indicator, and wherein the vehicle includes a second indicator configured to provide one or more indications to the operator of the approaching vehicle.

4. The deployable device system of claim 1, further comprising a plurality of deployable devices, wherein the vehicle is configured to transport the plurality of deployable devices.

5. The deployable device system of claim 4, wherein the control system is configured to control operation of the plurality of deployable devices to space the plurality of deployable devices along the perimeter.

6. The deployable device system of claim 4, wherein the control system is configured to coordinate control of the indicator of each deployable device of the plurality of deployable devices.

7. The deployable device system of claim 1, wherein the indication includes at least one of an audible sound or a visual alert.

8. The deployable device system of claim 7, wherein the indication includes the visual alert, and wherein the indicator includes at least one of a display or a light.

9. The deployable device system of claim 1, wherein the vehicle includes an area configured to store the deployable device during transportation of the vehicle and a charger configured to charge the deployable device.

10. The deployable device system of claim 1, wherein, when the deployable device is deployed, the control system is configured to maintain a position of the deployable device relative to the vehicle as the vehicle travels.

11. The deployable device system of claim 1, wherein the perimeter at least one of (i) entirely surrounds the scene or (ii) partially surrounds the scene.

12. The deployable device system of claim 1, wherein the scene includes at least one of an emergency scene or a construction site.

13. The deployable device system of claim 1, wherein the indication is indicative of at least one of an instruction for the approaching vehicle to slow down, merge lanes, or stop.

14. The deployable device system of claim 1, wherein the control system is configured to:
receive information acquired about the approaching vehicle;
determine, based on the information about the approaching vehicle, whether the approaching vehicle has entered a zone; and
transmit, responsive to a determination that the approaching vehicle has entered the zone, a signal to the approaching vehicle indicative of the scene,
wherein the zone is an area including the deployable device, the vehicle, and the scene.

15. The deployable device system of claim 1, wherein the deployable device is a ground vehicle, and wherein the propulsive element includes a plurality of tractive elements configured to engage a ground surface to propel the deployable device.

16. The deployable device system of claim 1, wherein the deployable device is an aerial vehicle, and wherein the propulsive element includes one or more rotors configured to lift the deployable device.

17. A deployable device comprising:
a chassis;
a propulsive element coupled to the chassis;
a motor coupled to the chassis and the propulsive element and configured to drive the propulsive element to propel the deployable device;
an indicator configured to provide one or more indications to an operator of an approaching vehicle; and
a control system configured to:
control the motor to position the deployable device at a position along a perimeter established proximate a scene; and
control the indicator to provide an indication of the scene.

18. The deployable device of claim 17, a vehicle is configured to transport the deployable device to the scene and deploy the deployable device.

19. The deployable device of claim 17, wherein the indication includes a visual alert, and wherein the indication is indicative of at least one of an instruction for the approaching vehicle to slow down, merge lanes, or stop.

20. A deployable device system for controlling operation of a plurality of deployable devices, the deployable device system comprising:
one or more processing circuits comprising one or more memory devices coupled to one or more processors, the one or more memory devices configured to store instructions thereon that, when executed by the one or more processors, cause the one or more processors to:
control a motor of each deployable device of the plurality of deployable devices to space the plurality of deployable devices along a perimeter established proximate a scene; and
control an indicator of each deployable device of the plurality of deployable devices to provide an indication,
wherein the indication includes at least one of an audible sound or a visual alert, and
wherein the indication is indicative of at least one of an instruction for the approaching vehicle to slow down, merge lanes, or stop.
